(19) United States
(12) Patent Application Publication
(10) Pub. No.: US 2019/0383310 A1
(43) Pub. Date: Dec. 19, 2019

(54) METHOD OF CONTROLLING A HYDRAULIC ACTUATOR DRIVE, CONTROLLER AND ACTUATOR DRIVE CONTROLLER

(71) Applicant: VOITH PATENT GMBH, HEIDENHEIM (DE)

(72) Inventors: CHRISTIAN ORTNER, SCHILLINGSFUERST (DE); FRIEDRICH HOFMANN, CRAILSHEIM (DE)

(21) Appl. No.: 16/489,926

(22) PCT Filed: Feb. 22, 2018
(86) PCT No.: PCT/EP2018/054354

§ 371 Date: Aug. 29, 2019

(30) Foreign Application Priority Data
Mar. 6, 2017 (DE) 10 2017 104 559.7
Mar. 30, 2017 (DE) 10 2017 106 840.6

(51) Int. Cl. F15B 5/00; F15B 20/00

(52) U.S. Cl. CPC F15B 5/006; F15B 20/00

(57) ABSTRACT

A method controls a hydraulic actuator drive that has an actuator and the position of the actuator is set by at least one electrohydraulic proportional valve that has at least one electrical input and at least one hydraulic output. First, the position of the actuator is detected and an actual position value is generated therefrom. Second, a target position value is specified in dependence on a default for a desired position of the actuator and a target/actual value difference is corrected by the at least one electrohydraulic proportional valve, so that the actuator assumes a position corresponding to the target position value. The method is characterized in that the target position value is also varied if the default remains unchanged for a desired position of the actuator.

The present invention relates to a method of controlling a hydraulic actuator drive, a controller for controlling at least one proportional valve for controlling a hydraulic actuator drive comprising an actuator, and an actuator drive controller, in particular according to the preambles of the independent claims.

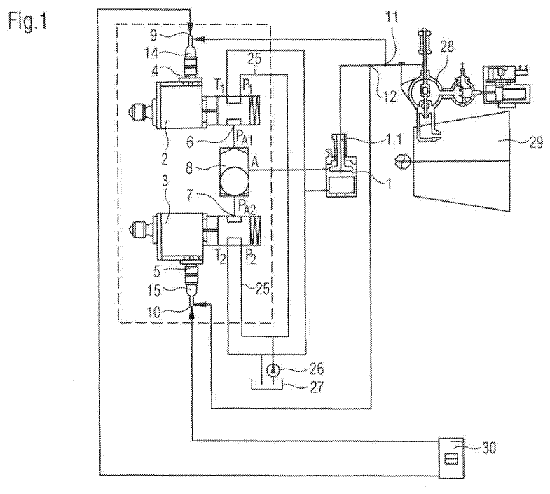

Actuator drive controllers are known in the art, for example, in the form of a way valve module. In one known generic way valve module, as shown in FIG. 1, two way valves are arranged redundantly to generate a hydraulic input pressure for the actuator drive, for example an actuating cylinder, in order to apply the hydraulic input pressure to the actuator drive so that the actuator drive or the actuator thereof is moved as a function of the hydraulic input pressure. For example, the actuator drive may in turn move a valve that controls the mass flow for supply to an engine or a driven machine. Using such a way valve module, the mass flow may be controlled in a manner that is very precise and highly dynamic.

Referring to FIG. 1, the known way valve module for controlling the hydraulic actuator drive 1, which has an actuator 1.1, has two redundantly arranged way valves 2, 3. In FIG. 1, the way valve module is demarcated by the dashed line.

Each way valve 2, 3 is designed as an electrohydraulic proportional valve with one electrical input 4, 5 and one hydraulic output 6, 7. A signal or electric current is fed to the respective electrical input 4, 5, which determines the position of the respective way valve 2, 3 and thus the hydraulic pressure that the way valve delivers at the hydraulic output 6, 7. In the configuration shown in FIG. 1 and also in one configuration of the present invention, each way valve 2, 3 in conjunction with the actuator 1 converts a constant input pressure or hydraulic input pressure, which is applied to the respective pressure input 25 and is generated, for example, by means of a pump 26 that pumps from a hydraulic tank 27, into a variable actuating stroke. The signal present at the electrical input 4, 5 or the corresponding current magnitude, for example between 4 and 20 mA, determines the stroke for the actuator drive 1 or actuator thereof 1.1.

The two way valves 2, 3 are connected via a shared hydraulic pressure selection device 8 so as to control the actuator drive 1 with a shared input pressure. The pressure at the hydraulic output 6 and/or hydraulic output 7 of the two way valves 2, 3 is fed to the hydraulic actuator drive 1 via the pressure selection device 8, so that the actuator thereof 1.1 assumes a certain position or executes a certain stroke as a function of the supplied hydraulic pressure. The valve 28 is in turn opened to a greater or lesser extent as a function of the stroke, which adjusts the mass flow for supplying an engine or driven machine, here for example a steam turbine 29.

Each way valve 2, 3 comprises an electronic monitoring circuit that detects the malfunction of the way valve 2, 3. In the event of a malfunction, the hydraulic pressure selection device 8 ensures that the other way valve 2, 3 takes over the function. This makes it possible to eliminate malfunctions during operation and even makes it possible to replace a way valve 2, 3 during operation. The redundancy of the way valves 2, 3 thus increases the operational safety and availability of the way valve module and reduces downtimes of the connected engine or driven machine.

For each way valve 2, 3, a position sensing device 11, 12 is furnished that detects the position of the actuator 1.1 of the actuator drive 1 and reports a corresponding actual position value to the position controller 14, 15 furnished in the respective way valve 2, 3.

A target position value for each way valve 2, 3 is predetermined by a controller 30 and is likewise supplied to the respective position controller 14, 15. Accordingly, a target position value input 9, 10 is furnished for each way valve 2, 3 and the position controller 14, 15 adjusts the target/actual value difference so that the actuator 1.1 of the actuator drive 1 executes the desired stroke or assumes the desired position.

The problem with the embodiment shown is that pressure drops may occur when changing over from one way valve 2 to the other way valve 3 and vice versa during operation, for example due to a failure of a position sensor 11, 12. Furthermore, it is difficult to check whether one of the two way valves 2, 3 is defective or whether the corresponding other way valve 2, 3 is able to take over the functionality by itself during a changeover.

If the corresponding position sensing 11, 12 fails, the associated way valve 2, 3 can no longer be operated, even if it is still fully functional. There is also a risk that particle deposits inside the hydraulic part may lead to a restricted travel range of the actuator drive 1, especially during prolonged constant operation. In extreme cases, the valve 28 may no longer be closed.

If a target value default is absent, the associated way valve 2, 3 can no longer be operated, even if it is still fully functional.

Accordingly, the object of the present invention, is to specify a method of controlling a hydraulic actuator drive that avoids at least one or more of the aforementioned drawbacks, starting from the known way valve module as an actuator drive controller for controlling a hydraulic actuator drive. The invention should also provide a corresponding controller and an actuator drive controller.

The object is solved according to the invention by a method, controller and actuator drive controller according to the independent claims. Advantageous and particularly expedient configurations of the invention are set forth in the dependent claims.

A method according to the invention, for controlling a hydraulic actuator drive that has an actuator the position of which is set by at least one electrohydraulic proportional valve having at least one electrical input and at least one hydraulic output, comprises the following steps:
Sensing the position of the actuator and generating an actual position value according to the sensed position;
Providing a default target position value and adjusting a target/actual value difference with the at least one electrohydraulic proportional valve so that the actuator assumes a position corresponding to the target position value, wherein the target position value is predetermined as a function of a default value for a desired position of the actuator, and wherein this default may, for example, be generated by an external system of which the actuator or a component actuated by the actuator is a part, such as, for example, a turbine controller, if a valve of a turbine is actuated using the actuator;
According to the invention, the target position value is varied even when the default for a desired position of the actuator is unchanged, i.e. in particular is unchanged by the external system.

The at least one electrohydraulic proportional valve may, for example, be designed as a way valve. However, other embodiments may also be considered, in which an electrical signal is converted into a hydraulic signal or into a hydraulic pressure.

For example, the hydraulic actuator drive has at least two electrohydraulic proportional valves that each respectively have at least one electrical input and at least one hydraulic output, the hydraulic outputs of which are interconnected in order to drive the actuator drive with a shared hydraulic input pressure. In this configuration, in the case of target position value variation, also called target position value manipulation, of the target value that is supplied to one of the electrohydraulic proportional valves, a pressure change in the hydraulic output of this electrohydraulic proportional valve may be compensated for by a change in the pressure in its hydraulic output that is set by means of at least one other electrohydraulic proportional valve, in order to keep the shared hydraulic input pressure constant for the actuator drive. This signifies that although the target position value is manipulated according to the invention even if this is not actually necessary due to the “external” target value specification, an undesired change in the position of the actuator is ruled out at least to a great extent. At the same time, the usually slight variation of the target position value avoids the above-described problem of the restricted travel range of the actuator drive and reduces the reaction time in the system, thus ensuring substantially reduced pressure drops.

The variation of the target position value may take place according to one embodiment of the invention as a regular or irregular oscillation superimposition on the target value, which is predetermined as a function of the default for the desired position of the actuator. The target value is thus impressed on an undulating or stepped curve, or is summed with an undulating or stepped curve that “oscillates” around a zero value, thus avoiding longer constant positions of the at least one electrohydraulic proportional valve or of other components used to drive the actuator drive.

Alternatively, the target position value may also be varied in the form of discrete magnifications and/or reductions of the target value, which is predetermined as a function of the default for the desired actuator position. In this embodiment, individual pulses are added to, or to speak impressed on, the target value in the form of a target value increase or decrease that then may be corrected in turn. In other words, a too-large or too-small target value is respectively specified for a short period of time before setting the “suitable” target value again.

According to one embodiment of the invention, the functionality of the electrohydraulic proportional valves and, in particular, other components used for controlling them is tested, in addition to varying the target value as shown, by successively deliberately reducing the target values fed to the electrohydraulic proportional valves and monitoring whether the pressure at the respective hydraulic output changes accordingly. In principle, such a test is also possible by deliberately increasing the supplied target values, and subsequently monitoring whether the pressure in the respective hydraulic output changes accordingly. In practice, however, reduction has proven particularly favorable.

In this test, preferably, the pressure reduction in one hydraulic output is compensated by a set pressure increase in another hydraulic output, or in the second embodiment, by a set pressure reduction in another hydraulic output, in order to keep the shared hydraulic input pressure constant for the actuator drive and thus not to undesirably influence the position of the actuator drive during the test.

After a compensation by changing the pressure in the other hydraulic output, the pressures in the hydraulic outputs are preferably conformed to each other again. This applies to the illustrated target position value variation (also known as target position value manipulation) and/or to the aforementioned test.

According to one embodiment, the variation of the target position value and/or the execution of the test may be switched off. In particular, if while varying the target position value unsuitable pressures are detected in the corresponding hydraulic output of the respective electrohydraulic proportional valve, the variation of the target position value is terminated and only the target position value, as a function of a default for a desired position of the actuator, is used. The same applies for the test. If implausible pressures are detected in a hydraulic output, the test is no longer performed and, in particular, an optical and/or acoustic warning and/or a warning message is issued.

Preferably, the actuator's position is detected using two or three position sensing devices and a 1-of-2, 1-of-3 or 2-of-3 selection is made based on the actual position values that the position sensing devices generate, and only the selected actual position value(s) is/are used to compensate for the target value/actual value difference or to vary the target position value. It is also possible to take an average of the generated actual position values and to use this average value to adjust the target value/actual value difference or vary the target position value.

A controller according to the invention for controlling at least one electrohydraulic proportional valve, which in turn is designed for controlling a hydraulic actuator drive comprising an actuator, has inputs and outputs for at least one actual position value and one target position value of the actuator position, and is designed to carry out a method according to the invention.

The actuator drive controller according to the invention is designed to control a hydraulic actuator drive that has an actuator, for example to control a hydraulic cylinder. The controller comprises at least two redundantly arranged electrohydraulic proportional valves for generating a hydraulic input pressure for the actuator drive. “Redundantly arranged” means that each electrohydraulic proportional valve by itself is able to ensure the functionality of the actuator drive controller, i.e. the availability of the hydraulic pressure for driving the actuator drive.

Each electrohydraulic proportional valve has at least one electrical input and at least one hydraulic output.

The hydraulic outputs of the at least two electrohydraulic proportional valves are connected with a shared input pressure via a shared hydraulic pressure selection device, designed in particular as a maximum pressure selection device, for driving the actuator drive.

The actuator drive controllers have a target position value input for each electrohydraulic proportional valve which is connected to the electrical input of the respective electrohydraulic proportional valve so that a target position value may be predetermined for the respective electrohydraulic proportional valve.

At least one position sensing device is provided for detecting the position of the actuator of the actuator drive, and the position sensing device generates an actual position value.

Each electrohydraulic proportional valve comprises a position controller that is designed to have a target position value from the target position value input and the actual position value from the position sensing device, to compensate for a target value/actual value difference.

The actuator drive controller according to the invention has at least one electronic switching device with which at least one target position value from a target position value input and/or an actual position value from the position sensing device may optionally be replaced by a default value. This possibility of replacing the target position value, which is predetermined in particular by an external system for a desired (i.e. desired by this system) position of the actuator, makes it possible to vary or manipulate the target value as described above, so that for controlling the actuator or adjusting the target value/actual value difference, a modified target position value may be used instead of the original target position value taken from the target position value input.

From among the target position values that the external system predetermines, a 1-of-2, 1-of-3 or 2-of-3 selection may be made, depending on the number of predetermined target values, and the respectively selected value or values may be used as the target position value(s). It is also possible to take an average and then use the average value.

The electronic switching device may be provided by software according to one embodiment of the invention, or by hardware according to another embodiment. In a software solution, a software-implemented logical module is furnished that replaces the target position value and/or actual position value with the default value.

By means of the configuration according to the invention, the two electrohydraulic proportional valves may still be operated even if a target position value and/or an actual position value is missing. In addition, a target value manipulation is possible that makes it possible to test the electrohydraulic proportional valves or the actuator drive, in particular even during operation. In this way, for example, it may be checked whether a valve that the actuator drive has actuated is still able to be closed.

The electrohydraulic proportional valve(s) may preferably be designed as way valves, as described above. Accordingly, a way valve module may be constructed, as described initially.

With the aid of target value manipulation or the target value variation shown, a pressure equilibrium may be generated in the way valve module, which minimizes the movement of the actuator of the actuator drive and thus of the connected valve, in the event of a way valve failure. This ensures comparatively limited pressure drops. The ongoing comparison of the currently-existing pressures at the outputs of the way valves and constant readjustment ensure that the system is able to react quickly.

The above-described sequential manipulation/variation of the target value with simultaneous measurement of the associated pressures, in particular at the respective hydraulic output of the way valves, advantageously allows the functionality of the two way valves to be checked even during operation. Advantageously, analogously to the general illustration for electrohydraulic proportional valves of any design, the target value of the first way valve is also reduced, with corresponding monitoring of whether the pressure in the output tracks the target value reduction, and the pressure reduction is compensated with the second way valve so that the actuator drive is not negatively influenced. The corresponding target value reduction and the monitoring of the associated pressure in the hydraulic output may then take place with the second way valve, the pressure reduction compensation then being accomplished by the first way valve.

It is advantageous that particle deposits that may be present in the hydraulic part may be flushed out through target value manipulation and a concomitant slight movement of the actuator of the actuator drive.

If two or three position sensing devices are furnished that respectively generate an actual position value as a function of the sensed actuator position, a 1-of-2, 1-of-3 or 2-of-3 evaluation may be provided so that the two way valves may still be operated even if one or two of the actual position values are missing, i.e. one of the two or three or two of the three position sensing devices no longer operate properly or the signal transmission is interfered with.

Even if one target value default is missing, the two way valves may still be operated by using a corresponding default value as a replacement, in particular through a 1-of-2, 1-of-3 or 2-of-3 selection.

Favorably, due to the self-test functionality described above, the extended functions of the actuator drive controllers may simply be switched off in the event of a malfunction, and the actuator drive controllers will still have the extended functionality shown in FIG. 1, so that additional failure risks are avoided.

According to one embodiment of the invention, a plurality of electronic switching devices are provided that can be switched individually to replace a target position value or actual position value.

The at least one switching device(s) may, for example, be designed as relays, in particular redundant relays.

It is also advantageous if, as shown, at least two or three position sensing devices are furnished for generating an actual position value, respectively as a function of the actuator position.

The two or three position sensing devices are advantageously connected to the at least two switching devices in such a way that a 1-of-2 or 1-of-3 or 2-of-3 selection is made from among the generated actual position values. Each switching device may be fed back its own actual position value. Alternatively, only one of the two or three actual position values is fed back to all switching devices.

It is particularly favorable if four electronic switching devices are furnished, two of which are each connected to one of the target position value inputs and the position controller of one way valve and one proportional valve, respectively, and also respectively have a default value input; and two of which are each connected to the position controller of one way valve and one position sensing device, respectively, and also respectively have a default value input. As a result, the two actual position values returned to the position controllers of the two way valves or proportional valves may be replaced by a default value, and the two target position values fed from a control system to the target position value inputs of the two way valves or proportional valves may be replaced by a respective default value.

According to one embodiment of the invention, the at least one switching device or every switching device is furnished with a switching input via which the corresponding switching device may be switched by applying a signal, in particular a predetermined current, to replace an actual position value or target position value with a default value.

In addition to the actuator drive controllers, a valve controller according to the invention comprises the hydraulically-actuable actuator and the actuator drive. The hydraulic actuator drive may, for example, have a pressure chamber that is connected to the pressure selection device to apply a hydraulic pressure as a function of the position of the two way valves or proportional valves. The actuator in this case may be actuated with the hydraulic pressure in the pressure chamber against the force of a preload spring of the hydraulic actuator drive.

According to one embodiment of the invention, some or all of the aforementioned components of the actuator drive controllers are integrated into a shared unit that may be connected between a control system and the electrohydraulic proportional valves. According to another embodiment, at least parts of the actuator drive controllers are integrated into the control system. It is also possible to integrate at least parts of the actuator drive controllers into the controller of the engine or driven machine, the valve or other component of which the actuator drive actuates.

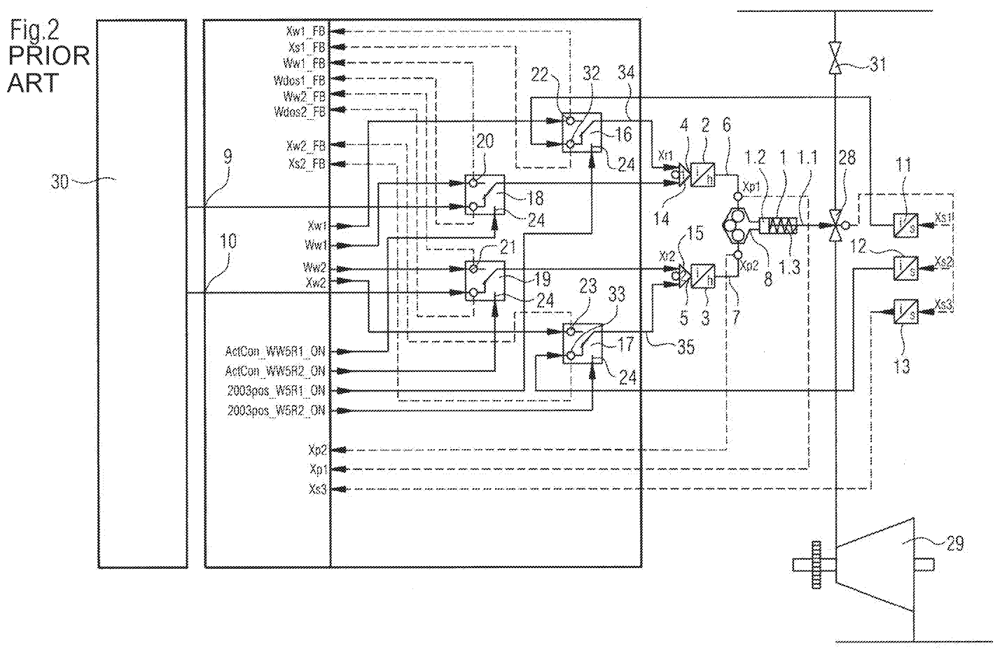

The invention will be described below through examples, with reference to an exemplary embodiment and FIG. 2.

In FIG. 2, corresponding components that have already been shown in FIG. 1, are marked with the same reference signs. In detail, an actuator drive 1 with an actuator 1.1 is shown that actuates a valve 28 of an engine or driven machine, in particular in the mass flow supply thereof. The drawing shows, by way of example, a steam turbine 29 that is supplied with live steam, the mass flow of which is adjusted by means of the valve 28. The steam turbine 29, for example, drives a compressor or electric generator. In particular, a rapid shut-off valve 31 may be connected upstream of the valve 28. A different engine or driven machine could however be furnished, in place of the steam turbine 29.

The way valve module has two electrohydraulic proportional valves 2, 3, which are referred to below as way valves due to their configuration in the present exemplary embodiment, and which convert an electrical signal or a current or voltage into a hydraulic pressure that is supplied to a pressure chamber 1.2 of the actuator drive 1 in order to extend the actuator 1.1 more or less against the force of a preload spring 1.3. The respective way valves 2 and 3 each have an electrical input 4 and 5 and hydraulic output 6 and 7 for this purpose. The hydraulic outputs 6, 7 are connected to the pressure selection device 8, which in turn supplies the pressure chamber 1.2 with a shared input pressure as a function of the hydraulic pressure at the hydraulic outputs 6, 7.

Although the invention is illustrated herein with reference to an actuator drive controller with two way valves, other electrohydraulic proportional valves 2, 3 may be furnished instead of the way valves. In addition, a controller according to the invention may also be used to control a hydraulic actuator drive in which only one electrohydraulic proportional valve is furnished.

The way valve module has a target position value 9, 10 for each way valve 2, 3, which is connected to the electrical input 4, 5 of the respective way valve 2, 3. In the connection, a position controller 14, 15 is provided for each way valve 2, 3, and an actual position value is fed to that controller in addition to a target position value. Unless replaced by a default value, the actual position value is derived from one of the position sensing devices 11, 12, that detects the position of actuator 1.1 of the actuator drive and generates an appropriate actual position value. A third position sensing device 13 is additionally furnished, that likewise generates an actual position value as a function of the position of the actuator 1.1 of the actuator drive and returns that value for further processing by a logic of the way valve module. According to another embodiment, the actual position values of all three position sensing devices 11, 12, 13 are first processed in such a way that one of these actual position values or also an average value of the actual position values is selected as suitable, in particular in the logic of the way valve module, and is fed to all position controllers 14, 15.

In addition to this actual position value of the third position sensing device 13, the measured hydraulic pressure from each hydraulic output 6, 7 of the two way valves 2, 3 may for example also be fed to the logic, as shown in FIG. 2. The values supplied to the logic may be analog values or, according to another embodiment, digital values.

Four electronic switching devices 16, 17, 18, 19 are furnished. The first electronic switching device 16 has an actual position value input 32 for the actual position value of the first position sensing device 11, and also a default value input 22 and an actual position value output 34. The actual position value output 34 is connected to the position controller 14 of the first way valve 2. As shown, alternatively a 1-of-2 selection or a 1-of-3 or 2-of-3 selection of the actual position values of all position sensing devices 11, 12, 13 is made, and the selected actual position value(s) are fed to the first electronic switching device 16.

The second electronic switching device 17 has an actual position value input 33 to which the actual position value from the second position sensing device 12 is applied, and which is correspondingly connected to the second position sensing device 12. The second switching device 17 additionally has a default value input 23 and an actual position value output 35. The actual position value output 35 is connected to the position controller 15 of the second way valve 3. The same applies here to the 1-of-2 selection and to the 1-of-3 or 2-of-3 selection of the first way valve 2.

The third electronic switching device 18 is connected on the input side to the target position value input 9 and on the output side to the position controller 14 of the first way valve 2. It also has a default value input 20. As long as no malfunction is detected, the default value input 20 is connected to the position controller 14 in order to use a varied target position value, instead of the target position value present at the target value input 9, to control the first way valve 2. Only when a malfunction is detected, the target position value input 9 is directly connected to the output of the third electronic switching device 18 and supplied to the first way valve 2 as a target value.

The fourth electronic switching device 19 also has a default value input 21 and is connected to the target position value input 10 on the input side, and to the position controller 15 of the second way valve 3 on the output side. Here too, as long as no malfunction has been detected, the default value from the default value input is fed to the position controller 15 of the second way valve 3. In the event of an error, however, the target value of the target position value input 10 is fed to position controller 15 of the second way valve 3.

The functionality described for the third and fourth electronic switching devices 18, 19 is also applicable for the first and/or second electronic switching device 16, 17, namely that as long as no malfunction is detected, the default value input is connected to the output, and if a malfunction is detected, the target position value input is connected to the output. Here either the actual position value input 32, 33 (malfunction detected) or the default value input 22, 23 (no malfunction detected) is connected to the actual position value output 34, 35.

An external 1-of-2, 1-of-3 or 2-of-3 selection of target values may also be envisioned.

Each switching device 16, 17, 18, 19 has a switching input 24 by means of which the device may be switched by applying a signal or a voltage or a current for replacing the actual position value or target position value on the input side by the default value at the default value input 20, 21, 22, 23, so that in the switched state, correspondingly, the default value of the default value input is applied on the output side of the switching device 16, 17, 18, 19 and fed to the corresponding position controller 14, 15. Although a hardware solution is shown here, using relays by way of example, the switching devices 16, 17, 18, 19 may also be implemented as software.

As shown by the dashed lines, numerous signals and/or pressures may be fed back for further processing in an electronic controller or control logic of the way valve module.

Although not shown in FIG. 2, a pressure supply, in particular with pump and hydraulic tank, may be furnished analogously to FIG. 1 in order to provide the necessary hydraulic pressure for the way valves 2, 3.

The control apparatus or actuator drive controller according to the invention, and the method according to the invention, may replace externally predetermined target position values, here for example the target position values of the control system 30, with default values that correspond to a changed target position value, in order to carry out the manipulation of the target value according to the invention, so as to avoid a too long stationary state and improve the reaction speed of the system, or in order to carry out a functional test as shown.

1-20. (canceled)

21. A method of controlling a hydraulic actuator drive (1) with an actuator and a position of the actuator is set by at least one electrohydraulic proportional valve having at least one electrical input and at least one hydraulic output, which method comprises the following steps of:
detecting the position of the actuator and an actual position value is generated therefrom;
specifying a target position value in dependence on a default for a desired position of the actuator;
controlling a difference between the target position value and the actual position value via the at least one electrohydraulic proportional valve so that the actuator assumes a position that corresponds to the target position value; and
varying the target position value even when the default for the desired position of the actuator is not changed.

22. The method according to claim 21, wherein:
the hydraulic actuator drive has at least two electrohydraulic proportional valves that respectively each have the at least one electrical input and the at least one hydraulic output, and the hydraulic output of each of the two electrohydraulic proportional valves are connected together for actuating the actuator drive with a shared hydraulic input pressure; and
during manipulation of the target position value supplied to one of the electrohydraulic proportional valves, in order to keep the shared hydraulic input pressure for the hydraulic actuator drive constant, a pressure change in the hydraulic output of the one electrohydraulic proportional valve is compensated by a change in a pressure at the hydraulic output of the at least one other of the electrohydraulic proportional valves.

23. The method according to claim 21, wherein a target position value variation takes a form of a regular or irregular oscillation superimposition on the target position value specified in dependence on the default for the desired position of the actuator.

24. The method according to claim 21, wherein a variation of the target position value takes place in a form of discrete magnifications and/or reductions of the target position value which is predetermined in dependence on the default for the desired position of the actuator.

25. The method according to claim 22, wherein in addition to a target value variation, the function of the electrohydraulic proportional valves and in particular of additional components used for controlling are tested by successively selectively reducing target values supplied to the electrohydraulic proportional valves and monitoring whether the pressure in the hydraulic output changes accordingly.

26. The method according to claim 25, wherein in a test a pressure reduction in one said hydraulic output is compensated by a set pressure increase in another said hydraulic output in order to keep constant the shared hydraulic input pressure for the hydraulic actuator drive.

27. The method according to claim 22, which further comprises equalizing pressures in the hydraulic outputs with each other again after a compensation by changing the pressure in the other hydraulic output.

28. The method according to claim 26, wherein a variation of the target position value and/or the test may be switched off.

29. The method according to claim 21, which further comprises detecting the position of the actuator with at least two position sensing devices and a 1-of-2, 1-of-3 or 2-of-3 selection is made from actual position values that the position sensing devices generate, wherein a selected actual position value is used for regulation.

30. A controller for controlling at least one electrohydraulic proportional valve for controlling a hydraulic actuator drive having an actuator, the controller comprising:
inputs and outputs for at least one actual position value and a target position value of a position of the actuator;
said controller configured to:
detect the position of the actuator and the actual position value is generated therefrom;
specify the target position value in dependence on a default for a desired position of the actuator;
control a difference between the target position value and the actual position value by the at least one electrohydraulic proportional valve so that the actuator assumes a position that corresponds to the target position value; and
vary the target position value even when the default for the desired position of the actuator is not changed.

31. An actuator drive controller for controlling a hydraulic actuator drive having an actuator, the actuator drive controller comprising:
a shared hydraulic pressure selection device;
at least two redundantly disposed electrohydraulic proportional valves for generating a hydraulic input pressure for the hydraulic actuator drive, each of said electrohydraulic proportional valves having at least one electrical input and at least one hydraulic output, hydraulic outputs of said at least two electrohydraulic proportional valves are interconnected via said shared hydraulic pressure selection device for actuating the hydraulic actuator drive with a shared input pressure;
a target position value input for each of said electrxohydraulic proportional valves and each said target position value input connected to said electrical input of a respective one of said electrohydraulic proportional valves;
at least one position sensing device for sensing a position of said actuator of the hydraulic actuator drive, said position sensing device generating an actual position value; and
each of said electrohydraulic proportional valves having a position controller configured with a target position value from said target position value input and the actual position value from said position sensing device, for controlling a difference between the target position value and the actual position value;
at least one electronic switching device with which at least one said target position value from said target position value input, and/or the actual position value from said position sensing device, may optionally be replaced by a default value.

32. The actuator drive controller according to claim 31, wherein said electronic switching device is one of a plurality of electronic switching devices that may be switched individually to replace the target position value or the actual position value.

33. The actuator drive controller according to claim 32, wherein said at least one position sensing device is one of at least two position sensing devices respectively furnished for generating in each case the actual position value in dependence on the position of the actuator.

34. The actuator drive controller according to claim 33, wherein:
said at least two position sensing devices are connected to at least two of said electronic switching devices in such a way that a first actual position value of a first switching device of said electronic switching devices is fed back, a second actual position value of a second switching device of said electronic switching devices is fed back and a third actual position value is fed back, as a reserve actual position value in case at least one of the two other actual position values fails; or
a 1-of-2, 1-of-3 or 2-of-3 selection is made from among the actual position values of said at least two position sensing devices, and a selected actual position value or selected actual position values are fed back to said first and second switching devices.

35. The actuator drive controller according to claim 32, wherein:
said electrohydraulic proportional valves each have a position controller;
four of said electronic switching devices are furnished;
a first two of said electronic switching devices are respectively interconnected with one said target position value input and said position controller of a respective said electrohydraulic proportional valve;
said first two of said electronic switching devices also respectively have a default value input; and
a second two of said electronic switching devices are respectively connected to said position controller of a respective said electrohydraulic proportional valve and a respective said position sensing device, and also respectively have a default value input.

36. The actuator drive controller according to claim 31, wherein said at least one electronic switching device has a switching input via which said electronic switching device is switched by applying a signal to replace the actual position value or the target position value with a default value.

37. The actuator drive controller according to claim 31, wherein said pressure selection device is a maximum pressure selection device.

38. A valve control apparatus, comprising:
a hydraulic actuator drive having an actuator and an actuator drive controller according to claim 31.

39. The valve control apparatus according to claim 38, wherein said hydraulic actuator drive has a pressure chamber that is connected to said shared hydraulic pressure selection device for applying a hydraulic pressure to said pressure chamber in dependence on the position of said two electrohydraulic proportional valves.

40. The valve control apparatus according to claim 39, wherein said actuator has a preload spring and is operable with the hydraulic pressure in said pressure chamber against a force of said preload spring.
